(19) United States
(12) Patent Application Publication
(10) Pub. No.: US 2007/0209757 A1
(43) Pub. Date: Sep. 13, 2007

(54) Method for attaching tubes using an adhesive

(76) Inventors: James F. Hengel, Romeo, MI (US); Pei-Chung Wang, Troy, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/372,720

(22) Filed: Mar. 10, 2006

(51) Int. Cl. B32B 37/12

(52) U.S. Cl. 156/294

(57) ABSTRACT

A method is provided for attaching together a pair of telescoped tubes. Prior to telescoping the tubes together, an adhesive storage cavity is formed on the surface of at least one of the tubes, and the adhesive cavity is filled with adhesive, so that adhesive within the adhesive cavity faces toward the surface of the other tube when the tubes are telescoped together. After the tubes are telescoped together, with the inner tube inside the outer tube, the adhesive within the storage cavity is cured so that the inner and outer tubes are adhesively attached together. During the curing of the adhesive, the adhesive will flow or expand out of the storage cavity to coat a portion of the opposing surfaces of the inner and outer tube.

### FIELD OF THE INVENTION

The present invention relates to a method and apparatus for attaching together a pair of tubes that are telescoped together with one tube inside the other.

### BACKGROUND OF THE INVENTION

It is known in the manufacture of motor vehicle frame structures and in the manufacture of other articles to telescope together a pair of tubes by inserting an inner tube into an outer tube. The tubes may be of round, rectangular or any other cross section. The tubes are attached together via welding, adhesives, or mechanical fasteners to form a strong and lightweight load-bearing structure.

It would be desirable to provide a new and improved method for adhesively attaching together a pair of telescoped tube.

### SUMMARY OF THE INVENTION

A method is provided for attaching together a pair of telescoped tubes. Prior to telescoping the tubes together, an adhesive storage cavity is formed on the surface of at least one of the tubes, and the adhesive cavity is filled with adhesive. The adhesive cavity faces toward the surface of the other tube when the tubes are telescoped together. After the tubes are telescoped together, with the inner tube inside the outer tube, the adhesive within the storage cavity is cured so that the inner and outer tubes are adhesively attached together. During the curing of the adhesive, the adhesive will flow out of the storage cavity to coat a portion of the opposing surfaces of the inner and outer tube.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a section view taken through an inner and outer tube, with each tube having an adhesive storage cavity formed therein;

FIG. 2 shows the inner and outer tubes of FIG. 1 telescoped together;

FIG. 3 is a section view showing a second embodiment of the invention;

FIG. 4 is a end view taken in the direction of arrows 4-4 of FIG. 3;

FIG. 5 is a section view taken in the direction of arrows 5-5 of FIG. 3;

FIG. 6 is a section view of yet another embodiment of the invention;

FIG. 7 is a section view taken in the direction of arrows 7-7 in FIG. 6; and,

FIG. 8 is a section view showing the inner tube formed as a cast or machined node for telescoping with and connecting together two outer tubes.

### DETAILED DESCRIPTION OF THE EXEMPLARY EMBODIMENTS

The following description of certain exemplary embodiments is merely exemplary in nature and is not intended to limit the invention, its application, or uses.

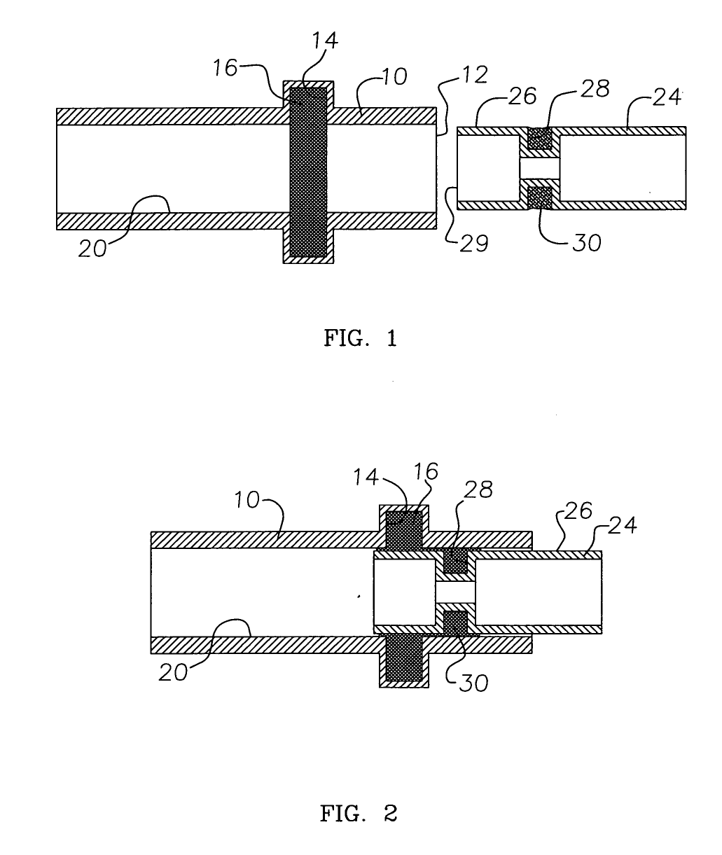

Referring to FIG. 1, an outer tube 10 is provided having an open end 12. An adhesive storage cavity 14 is provided on the inner surface 20 of outer tube 10 at a certain distance from the open end 12 and is filled with an adhesive 16. The storage cavity 14 extends circumferentially around the inner surface 20 of the tube 10 and is formed in the wall of the tube 10 by a conventionally known manufacturing process. For example, the storage cavity may be formed by machining, hydroforming, forming the tube over a mandrel, or upsetting the tube to cause radial outward displacement of the tube wall into a forming die.

The adhesive 16 is preferably an adhesive of the type that is dispensed in liquid form, so that the adhesive 16 may be readily placed within the storage cavity 14. The adhesive 16 will solidify or partially cure itself to thereby remain embedded in place within the storage cavity 14. The adhesive 16 may be sufficiently viscous to remain in its embedded condition within the cavity during transportation and handing of the tube.

FIG. 1 also shows an inner tube 24 having an outer surface 26 that is sized to fit closely within the inner surface 20 of the outer tube 10. Inner tube 24 has an adhesive storage cavity 28 that is filled with an adhesive 30. As seen in FIG. 1 the adhesive storage cavity 28 is a groove that extends circumferentially around the outer surface 26 of the inner tube 24 at a certain distance from the end 29 of the inner tube 24. Like the adhesive cavity 14 of the outer tube 10, the storage cavity 28 of the inner tube 24 may be formed by any known manufacturing process. The adhesive 30 is placed into the adhesive storage cavity 28 prior to the insertion of the inner tube 24 into the outer tube 10.

Referring now to FIG. 2, it is seen that the outer tube 10 and the inner tube 24 have been telescoped together, either by moving the outer tube 10 onto the inner tube 24, or by inserting the inner tube 24 into the outer tube 10. As seen in FIG. 2, the tubes 10 and 24 overlap one another such that the adhesive storage cavity 14 and the storage cavity 28 are axially spaced from each other somewhat, rather than directly registering with one another, so that the adhesive stored within the cavity faces a surface of the other tube.

After the tubes 10 and 24 have been telescoped together to the position of FIG. 2, the tubes are permanently attached by curing the adhesive 16 and the adhesive 30. Curing of the adhesive is achieved by heating the tubes, thereby causing the adhesive beads 16 and 30 to soften and flow out of the storage cavities and into contact with the opposing tube surface. In particular, the adhesive 16 in the adhesive storage cavity 14 of the outer tube 10 will bond with the outer surface 26 of the inner tube 24. Likewise the adhesive 30 within the adhesive storage cavity 28 of the inner tube 24 will bond with the inner surface 20 of outer tube 10. The adhesive is preferably formulated to expand somewhat upon heating so that the adhesive will flow out of the cavities and also flow lengthwise somewhat into the space between the inner surface 20 of the outer tube 10 and the outer surface 26 of the inner tube 24. In particular, as seen in FIG. 2, the adhesive 16 has flowed out of the adhesive storage cavity 14 and the adhesive 30 has flowed out of the adhesive storage cavity 28 and axially of the tubes along the space between the outer surface 26 of the inner tube 24 and inner surface 20 of the outer tube 10. In this way the surface area of the tubes that is subjected to the adhesive bonding will be substantially greater than just the axial dimension of the storage cavities 14 and 28. In instances where the tubes are intended to carry a fluid, the adhesive material will also act as an adhesive sealer to provide a liquid and gas tight connection.

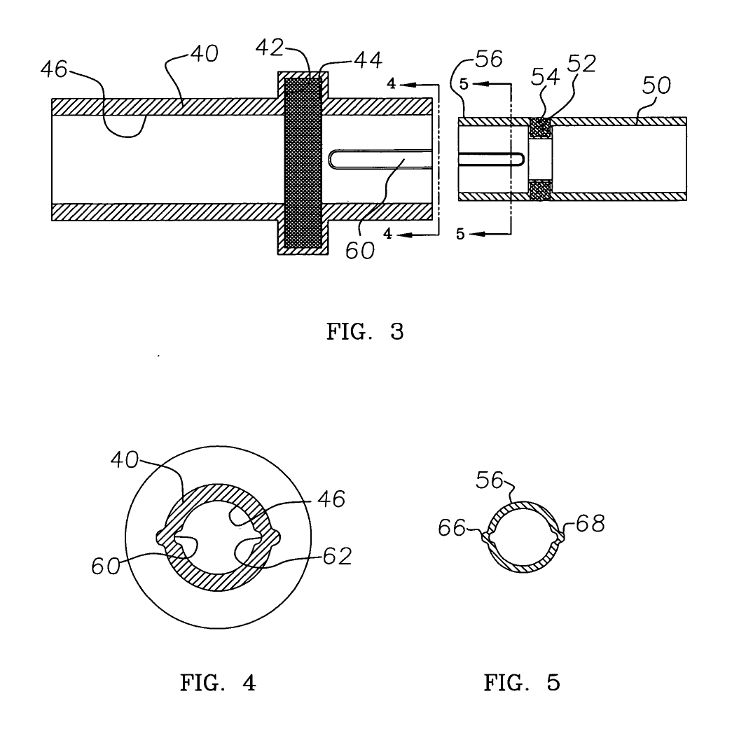

Referring to FIGS. 3, 4, and 5 a second embodiment of the invention is shown in which an outer tube 40 has an adhesive storage cavity 42 filed with adhesive 44. Outer tube 40 has an inner surface 46. An inner tube 50 has an adhesive storage cavity 52 filled with an adhesive 54. An outer surface 56 of the inner tube 50 is sized to fit closely with the inner surface 46 of the outer tube 40.

The tubes 40 and 50 of FIG. 3 are of circular cross section and it may be desirable or necessary to orient the outer tube 40 and the inner tube 50 to a predetermined rotary orientation by providing one more interlocking splines on the tubes 40 and 50. In particular, but not limited to, as seen in FIGS. 3 and 4 the outer tube 40 has a pair of splined channels 60 and 62 formed on opposing sides of the inner surface 46 thereof. The splined channels 60 and 62 are preferably formed during hydroforming or any other manufacturing process that is employed to form the adhesive storage cavity 42. FIGS. 3 and 5 show that the inner tube 50 has pair of splines 66 and 68 formed on the outer surface 56 thereof. It will be understood and appreciated that when the tube 40 and 50 are telescoped together, the splines 66 and 68 will fit closely within the spline channels 60 and 62 of the outer tube 40, thereby establishing the outer tube 40 and inner tube 50 at a desired rotary orientation. When, the adhesive beads 44 and 54 are cured the engagement of the splines 66 and 68 within the spline channels 60 and 62 will strengthen the connection between the two tubes, and is particularly desirable in those cases where the tubes will be subjected to torsional loading as the torsional loading is of course resisted by mechanical interlock of the splines 66 and 68 within the spline channels 60 and 62.

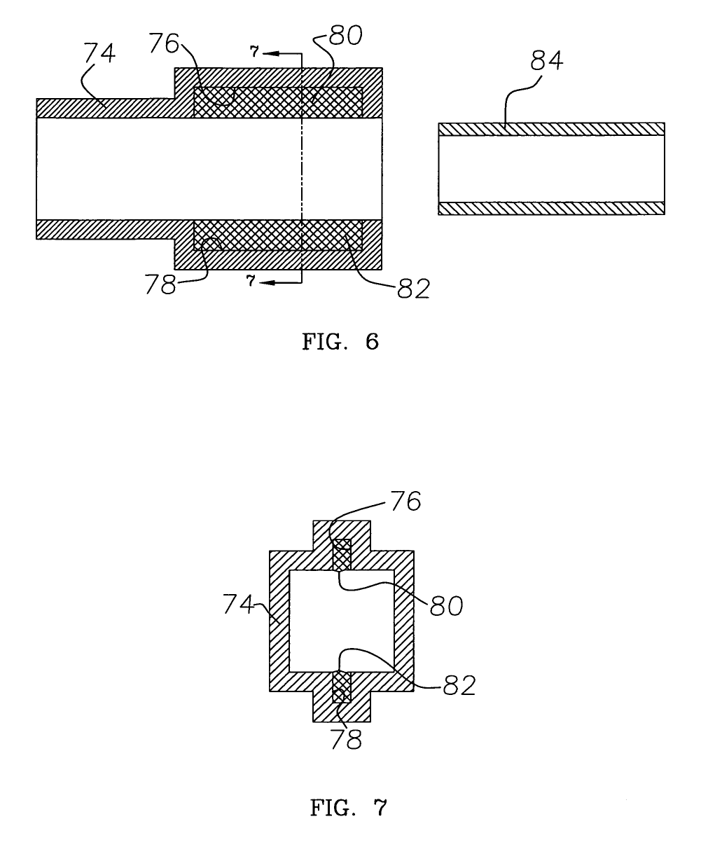

Referring to FIGS. 6 and 7 yet another embodiment of the invention is shown. The outer tube 74 is a rectangular tube and has an axial extending adhesive storage cavity 76 provided in top wall thereof and an axially extending adhesive storage cavity 78 provided in lower wall thereof. Storage cavities 76 and 78 are respectively filled with adhesive beads 80 and 82. In the example of FIG. 6, it is seen that the inner tube 84 is a plain rectangular tube that is not equipped with an adhesive storage cavity. When the inner tube 84 is inserted into the outer tube 74, the adhesive beads 80 and 82 face toward the opposing walls of the inner tube 84 so that when the adhesive is cured, the adhesive beads 80 and 82 will flow from their storage cavities and adhere the tube 74 and 84 together.

In the embodiment of FIGS. 6 and 7, storage cavities are shown on only two walls of the outer tube 74, however additional adhesive storage cavities may be provided on either the outer tube or the inner tube in order to provide a joint of greater strength.

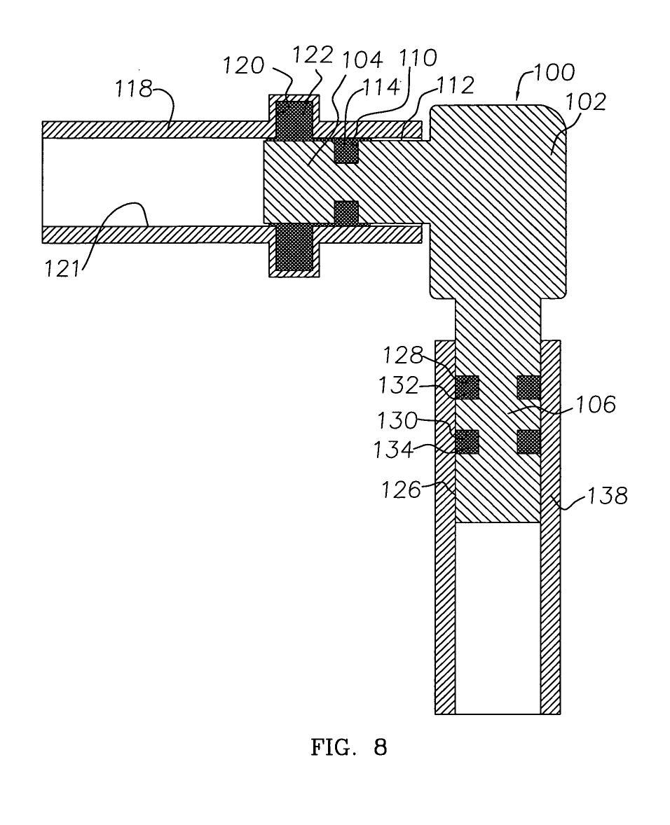

FIG. 8 shows another embodiment of the invention. A node 100 is of cast or machined construction and includes a knob 102 with a first solid inner tube 104 extending in one direction and a second solid inner tube 106 extending in another direction. The first solid tube 104 has an adhesive storage cavity 110 on the outer surface 112 thereof. The adhesive storage cavity 110 is filled with an adhesive 114. A first outer tube 118 has a circumferential extending storage cavity 120 formed in its inner surface 121, and filled with adhesive 122. The first outer tube 118 is installed over the first solid inner tube 104. The second solid inner tube 106 has a pair of adhesive storage cavities 128 and 130 formed on the outer surface 126 thereof and respectively filled with adhesive 132 and 134. A second outer tube 138 is installed over the second solid inner tube 106. Curing of the adhesive 114 and 122 will attach the first outer tube 118 to the first solid inner tube 104. Curing of the adhesive 132 and 134 will attach the second outer tube 138 to the second inner tube 106. Thus, the node 100 will serve to connect together the outer tubes 118 and 138. This use of a node to attach together piece of tube is particularly useful in the construction of structural frameworks such as in vehicle body and chassis manufacture for motor vehicles.

It will be understood and appreciated that the teachings of the forgoing description of an adhesive joint attachment provided herein furnishes the design engineer with a multitude of design alternatives that can be effectively and alternately employed in the making of automotive vehicle structures or in the manufacture of other articles. In particular the tubes that telescope together can be of any cross sectional shape and can be manufactured using any known technology. Adhesive storage cavities may be provided to extend circumferentially all around the surface of the tube or, alternatively can be formed via grooves or pockets formed in the tube surface and extending only part way around the circumference of the tube surface. Likewise, the adhesive storage cavity that of the type that extends longitudinally along the axial length of the tube can be of substantial length or of very short length. The longitudinally extending adhesive storage cavities can be closed at the end as shown in FIG. 6 or may have an open end that communicates with the end of the tube. In addition, one of the tubes may have a circumferential extending adhesive storage cavity, while the mating tube has an axial extending adhesive storage cavity.

The designer may choose among available adhesive to obtain an adhesive having the characteristics that allow the adhesive to be easily dispensed and embedded within the cavities, and to remain in place within the cavity during the handling and transportation of the tubes as convenient to the manufacturing process in which the tubes are employed. Furthermore, it will be understood that the designer may adjust the formulations of the adhesive to provide the desired viscosity and or expansion characteristics that will cause the adhesive to flow or expand partly out of the storage cavity to coat a substantial portion of the opposing surfaces of the inner and outer tubes.

In addition the adhesive can be cured by the addition of heat via any known force or process. For example electrical resistance heating may be employed, or the assembled tubes can be passed through an oven such as a paint curing oven commonly in motor vehicle assembly plants.

And although the drawings herein show the tubes as thin walled tubes, it will be appreciated that the adhesive joining method herein may also be useful when the tubular shape is of solid construction. For example, referring again to the embodiment of FIGS. 3, 4 and 5, the inner tube 50 may be a solid casting or a machined body in which the tube 50 is not hollow, but rather is of solid metal, having a circular outer surface 56 that will insert into the outer tube 40. In the manufacture of motor vehicle structures, such a solid casting will typically have two or more of the solid tubes 50 thereon, so that the casting acts as a node for joining together two or more of the outer tubes 40.

Although the drawings shown herein depict the adhesive storage cavity as being rectangular in cross section it will be appreciated that the walls defining the storage cavity may have any cross section that is convenient to manufacture. For example the storage cavity may be rounded or hemispherical or triangular in shape so long as the resultant shape is sized appropriately to store the desired volume of adhesive.

What is claimed is:

1. A method of attaching together an inner tube and an outer tube that telescope together, comprising:
forming on the surface of at least one of the tubes, prior to the telescoping of the tubes together, an adhesive storage cavity that will face toward the surface of the other tube once the tubes are telescoped together;
filling the adhesive storage cavity with adhesive;
telescoping the tubes together with the inner tube inside the outer tube so that the adhesive within the adhesive storage cavity faces toward the other tube;
and curing the adhesive so that the inner and outer tubes are adhesively attached.

2. The method of claim 1 further comprising the adhesive being a heat curable adhesive that upon being heated flows at least partially out of the storage cavity to coat surface portions of the inner and outer tubes.

3. The method of claim 1 further comprising the adhesive being characterized by sufficient viscosity and partial curing to cause the adhesive to remain embedded within the adhesives storage cavity during handling of the tube prior to the telescoping together of the tubes.

4. The method of claim 1 in which the adhesive storage cavity is a groove that extends circumferentially around at least a portion of the circumference of at least one tube.

5. The method of claim 1 in which the cavity is a groove that extends axially along the surface of at least one tube.

6. The method of claim 1 in which the inner tube is formed as solid member of either cast or machined manufacture that will telescope with at least one outer tube.

7. The method of claim 6 in which the solid member has a plurality of inner tubes formed thereon to join together a plurality of outer members.

8. The method of claim 1 in which both the inner and outer tubes have adhesive storage cavities provided thereon and the adhesive storage cavity are located such that upon telescoping together of the inner and outer tubes the adhesive storage cavities of each tube are not registered with one another and instead register with an opposed surface of the other tube.

9. A method of attaching together an inner tube and an outer tube that telescope together, comprising:
forming a cavity on the outer surface of the inner tube and filling the cavity with adhesive;
forming a cavity on the inner surface of the outer tube and filling the cavity with adhesive;
placing the inner tube within the outer tube so that the adhesive filled cavity of the inner tube is facing the inner surface of the outer tube and the adhesive cavity of the outer tube is facing the outer surface of the inner tube;
and curing the adhesive so that the inner and outer tubes are adhesively attached.

10. The method of claim 9 in which the cavity formed on the outer surface of the inner tube is a groove that extends circumferentially at least part way around the circumference of the outer surface of the inner tube and opens outwardly and the cavity formed on the inner surface of the outer tube is a groove that extends circumferentially at least part way around the circumference of the inner surface of the outer tube and opens inwardly.

11. The method of claim 9 in which the cavity formed on the outer surface of the inner tube is a groove that extends longitudinally along the outer surface of the inner tube and opens outwardly toward the inner surface of the outer tube and the cavity formed on the inner surface of the outer tube is a groove that extends longitudinally along the inner surface of the outer tube and opens inwardly toward the outer surface of the inner tube.

12. The method of claim 9 in which the cavity formed on one of the tubes is a groove that extends circumferentially at least part way around the circumference of the tube and the cavity that is formed on the other tube is a groove that extends longitudinally along the surface of that tube.

13. The method of claim 9 in which the adhesive is a liquid that is dispensed into the cavities of the respective tubes and assumes a condition so as to be self retained within the cavity.

14. The method of claim 10 in which the adhesive is a heat curable adhesive and upon heating of the adhesive, the adhesive flows from the adhesive cavities and flows longitudinal between the inner surface of the outer tube and the outer surface of the inner tube to coat and bond together a substantial portion of the opposing surfaces of the inner and outer tubes.

15. The method of claim 14 in which the adhesive is formulated to expand upon heating.

16. A method of connecting together a pair of tubes of different size, comprising:
embedding an adhesive within a cavity provided on the outer surface of the smaller of the tubes;
embedding an adhesive within a cavity provided on the inner surface of the larger of the tubes;
assembling the tubes with the smaller tube inside the larger tube;
and curing the adhesive so that the adhesive embedded in the cavity of the smaller tube bonds with the larger tube and the adhesive embedded in the cavity of the larger tube bonds with the smaller tube.

17. The method of claim 16 further comprising:
forming the cavity on the outer surface of the smaller tube by providing a groove on the outer surface.

18. The method of claim 16 further comprising: forming the cavity on the inner surface of the larger tube by providing a groove on the inner surface.
